(19) United States
(12) Patent Application Publication
(10) Pub. No.: US 2014/0325605 A1
(43) Pub. Date: Oct. 30, 2014

(54) SYSTEM FOR STORAGE SECURITY OF CLOUD SERVER IN CLOUD COMPUTING ENVIRONMENT AND METHOD THEREOF

(71) Applicants: INTELLECTUAL DISCOVERY CO., LTD, Seoul (KR); KINGS INFORMATION & NETWORK CO., LTD., Hanam-si (KR)

(72) Inventors: Young Ho JUNG, Hanam-si (KR); Jong Kyung BAEK, Hanam-si (KR)

(73) Assignees: KINGS INFORMATION & NETWORK CO., LTD., Hanam-si (KR); INTELLECTUAL DISCOVERY CO., LTD, Seoul (KR)

(21) Appl. No.: 14/266,419

(22) Filed: Apr. 30, 2014

(30) Foreign Application Priority Data
Apr. 30, 2013 (KR) 10-2013-0048339
Apr. 30, 2013 (KR) 10-2013-0048340

(51) Int. Cl. H04L 29/06

(52) U.S. Cl. CPC H04L 63/10; H04L 63/20
USPC 726/4

(57) ABSTRACT

The present invention relates to an apparatus for providing storage security of a cloud server in a cloud computing environment in which a client terminal is connected to the cloud server over a communication network. The apparatus includes a monitor configured to monitor which file data is requested for writing or transferring among file data stored in a storage of the cloud server and a controller configured to detect whether the file data monitored by the monitor is the file data belonging to a predetermined secure space and to block or hold the writing or transfer for the file data when the detected file data belongs to the predetermined secure space.

### CROSS-REFERENCE TO RELATED APPLICATIONS

This application is based on and claims priority to Korean Patent Application No. 10-2013-0048339 filed on Apr. 30, 2013, and Korean Patent Application No. 10-2013-0048340 filed on Apr. 30, 2013, the disclosure of which are incorporated herein in its entirety by reference.

### FIELD OF THE INVENTION

The present invention relates to a system for providing storage security of a cloud server in a cloud computing environment and a method thereof. More specifically, the present invention relates to a system for providing storage security of a cloud server in a cloud computing environment and a method thereof, capable of preventing file data stored in a storage of the cloud server from being leaked out by access made through a network hacking or a device such as a storage medium in a cloud computing environment in which a client terminal is connected to the cloud server over a wired/wireless communication network.

### BACKGROUND OF THE INVENTION

In general, a technology called a cloud computing means an Internet-based (cloud) computing technology. The cloud computing has a hidden complex infrastructure as if the Internet is expressed as a cloud in a computer network topology and may be a computing style which provides IT-related functions in the type of a service. Users can make use of the services provided from the cloud computing by using the Internet.

In other words, the cloud computing is a technology which employs the combination of the concept of various computing, such as virtualized computing, utility computing, on-demand computing and the like and a communication technology, implements one virtual computer or service by integrating multiple data centers typically made up of a large number of computers using a virtualization technology, and provides a variety of software, security solutions and computing power in the way of an on-demand service to users who access to the virtual computer or service.

Further, the cloud computing is known as ‘an on-demand outsourcing service of IT resources over the Internet’ and enables users to perform their desired tasks in the way of storing programs or documents that were otherwise stored individually in a personal computer or a server of a company in an Internet-based virtual server or storage and running a cloud application such as a web browser or the like using various terminals inclusive of a personal computer.

In this case, the users can selectively pick out and use the computing resources such as a cloud application, storage, OS, security, and the like at their desired time and as much as the users want and pay for based on the amount of use of computing resources.

Although a full-fledged cloud computing has not yet made, researches on a cloud computing service, service platform and virtual technology are actively ongoing under the leadership of the large companies such as Google, Microsoft, IBM, and the like.

On the other hand, only authorized users can download file data from a cloud server in a cloud computing environment. Further, there is no way presently to prevent malicious unauthorized users from having an access to a storage of the cloud server and taking away file data, so that it is needed to have a method to monitor and block that file data stored in the storage of the cloud server are taken out.

Furthermore, there is no way presently to monitor that authorized users maliciously have access to a storage of the cloud server directly and leak out file data through a device such as a storage medium. Accordingly, a technology is needed, which monitors whether file data stored in a storage of the cloud server is leaked out.

### SUMMARY OF THE INVENTION

In view of the above, the present invention provides a system for providing storage security of a cloud server in a cloud computing environment and a method thereof, which are capable of preventing beforehand a malicious authorized user from directly having access to a storage of a cloud server and leaking out file data through a device such as a storage medium in a cloud computing environment in which a client terminal is connected to a cloud server over a wired/wireless communication network.

Further, the present invention provides a system for providing storage security of a cloud server in a cloud computing environment and a method thereof, which are capable of preventing beforehand file data stored in a storage of a cloud server from being leaked out by a network hacking in the cloud computing environment in which a client terminal is connected to a cloud server over a wired/wireless communication network.

In accordance with a first aspect of the embodiment of the present invention, there is provided an apparatus for providing a storage security of a cloud server in a cloud computing environment in which a client terminal is connected to the cloud server over a communication network and the apparatus includes a monitor configured to monitor which file data is requested for writing or transferring among file data stored in a storage of the cloud server and a controller configured to detect whether the file data monitored by the monitor is the file data belonging to a predetermined secure space and to block or hold the writing or transfer for the file data when the detected file data belongs to the predetermined secure space.

Further, the controller blocks or holds the writing or transfer for the detected file data based on a predetermined security policy.

Further, the apparatus includes a file read monitor installed in a kernel layer of a file system included in the cloud server and configured to monitor which file data is read among the file data stored in the storage of the cloud server and a file read controller configured, in case that file data monitored for its reading by the file read monitor is the file data stored in the predetermined secure space, to extract and store information of the file data monitored for its reading.

Further, the controller is configured to identify whether the file data monitored by the monitor is a predetermined monitoring target, before detecting whether the file data monitored by the monitor is the file data belonging to the predetermined secure space and in case that information of the file data monitored by the monitor is identical to information of the file data stored by the file read controller, determine that the file data monitored by the monitor is the file data belonging to the predetermined secure space.

Further, information of the file data extracted by the file read controller is stored in a separate storage space in a form of list and includes at least one of a portion of the relevant file data, a file path, drive information, and a process ID.

Further, the monitor further includes a file write monitor that is installed in a kernel layer of a file system included in the cloud server and that monitors which file data is written among the file data stored in the storage of the cloud server.

Further, in case that the file data monitored for its writing by the file write monitor is a predetermined monitoring target, when a portion identical to the file data stored and read by the file read controller is founded in contents of the file data that try to write file when reading in the same process, the controller is configured to determine that the writing is intended to copy the file data that was tried to read in the past, determine a destination of the relevant file data and block or hold the writing of the relevant file data when the destination is the outside or the location that violates a predetermined security policy.

Further, the monitor further includes a file transfer monitor that is installed in the kernel layer of the network system included in the cloud server and that is configured to monitor which file data is transferred among the file data stored in the storage of the cloud server.

Further, in case that the file data t monitored for tis transfer by the file send monitor is a predetermined network monitoring target, when a portion identical to the file data stored and read by the file read controller is founded in contents of the file data that was tried for file transfer in the same process, the controller is configured to determine that the file data trying for file transfer is intended to transfer the file data that was tried to read in the past to the outside.

In accordance with a second aspect of the embodiment of the present invention, there is provided a method for providing a storage security of a cloud server in a cloud computing environment in which a client terminal is connected to the cloud server over a communication network, and the method includes monitoring, by a monitor installed in a kernel layer of a system that is included in the cloud server, whether there is a writing request or transfer request for a file data among file data stored in a storage of the cloud server, detecting, by a controller connected to the monitor, whether the file data monitored in the monitoring step is the file data belonging to a predetermined secure space and when the file data monitored is detected to be the file data belonging to the predetermined secure space, controlling the controller to block or hold a writing or transfer of the file data detected.

Further, in the controlling step, the controller is configured to block or hold the writing or transfer of the file data detected, based on a predetermined security policy. Further, the method includes, before the monitoring step, monitoring, by a file read monitor installed in a kernel layer of the file system included in the cloud server, which file data is read among the file data stored in the storage of the cloud server and in case that the file data monitored for its reading by the file read monitor is the file data stored in the predetermined secure space, controlling a file read controller connected to the file read monitor to extract and store information of file data monitored for its reading.

Further, the detecting step includes before detecting whether the file data monitored by the monitor is the file data belonging to the predetermined secure space, allowing the controller to identify whether the file data monitored by the monitor is the predetermined monitoring target and in case that information of the file data monitored by the monitor is identical to information of the file data stored by the file read controller, allowing the controller to determine that the file data is the file data belonging to the predetermined secure space.

Further, the information of the file data extracted by the file read controller at the controlling step is stored in a separate storage space in a form of list and includes at least one of a portion of the relevant file data, a file path, drive information and a process ID.

Further, the monitoring step includes monitoring, by a file write monitor that is installed in a kernel layer of a file system included in the cloud server and included in the monitor, which file data is written among file data stored in the storage of the cloud server.

Further, wherein in case that the file data monitored for its writing by the file write monitor is determined to be the monitoring target, when a portion identical to the file data stored and read by the file read controller is founded in contents of the file data that is tried to write file when reading in the same process and the controlling step includes determining that the writing is intended to copy the file data that was tried for reading in the past, determining a destination of the relevant file data and blocking or holding the writing of the file data when the destination is the outside or the site that violates the predetermined security policy.

Further, the monitoring step includes monitoring, by a file transfer monitor that is installed in a kernel layer of a network system included in the cloud server and is included in the monitor, which file data is transferred among the file data stored in the storage of the cloud server.

Further, in case that the file data monitored for its sending by the file send monitor is a predetermined network monitoring-target, when a portion identical to the file data stored and read by the file read controller is founded in contents of the file data that is tried to send file when trying to read in the same process and the controlling step includes determining that the file data trying for file transfer is intended to transfer the file data that was tried to read in the past to the outside.

According to a system for providing storage security of a cloud server in a cloud computing environment and a method thereof in accordance with an embodiment of the present invention, it may be possible to prevent an authorized user from directly having access to a storage of the cloud server maliciously and leaking out file data through a device such as a storage medium in the cloud computing environment in which a client terminal is connected to a cloud server over a wired/wireless communication network. Further, it may be possible to prevent file data stored in a storage of the cloud server from being leaked out by network hacking in a cloud computing environment in which a client terminal is connected to the cloud server over a wired/wireless communication network.

### BRIEF DESCRIPTION OF THE DRAWINGS

The above and other objects and features of the present invention will become apparent from the following description of embodiments given in conjunction with the accompanying drawings, in which:

FIG. 1 is an overall block diagram of a system for providing storage security of a cloud server in a cloud computing environment in accordance with an embodiment of the present invention;

FIG. 2 illustrates a detailed diagram of the kernel structure of a file and network system in a cloud server that is applied in an embodiment of the present invention;

FIGS. 3A and 3B are diagrams illustrating the comparison of information on file data through a file write controller or a file transfer controller that is applied in an embodiment of the present invention; and

FIGS. 4A and 4B are overall flowcharts illustrating a method for providing storage security of a cloud server in a cloud computing environment in accordance with an embodiment of the present invention.

### DETAILED DESCRIPTION OF THE EMBODIMENTS

Hereinafter, the advantages and features of exemplary embodiments of the present invention and methods of accomplishing them will be clearly understood from the following description of the embodiments taken in conjunction with the accompanying drawings. However, the present invention is not limited to those embodiments and may be implemented in various forms. It should be noted that the embodiments are provided to make a full disclosure and also to allow those skilled in the art to know the full scope of the present invention. Therefore, the present invention will be defined only by the scope of the appended claims. Similar reference numerals refer to the same or similar elements throughout the drawings. The term “and/or” used herein includes all combinations of each of the items and one or more of them described herein.

Although the terms “a first”, “a second”, and the like are used to describe a variety of elements, components and/or sections, it is understood that these elements, components and/or sections are not limited by these terms. The use of the terms is intended to distinguish the elements, components or sections from other elements, components or sections. Thus, it is understood that a first element, a first component or a first section mentioned below may be a second element, a second component, or a second section within the spirit of the present invention, as well.

It should be noted that the terminologies used herein is merely intended to describe the embodiments and do not limit the scope of the present invention.) In the present application, the representation of the singular, unless it is clearly indicated in the phrase otherwise, includes multiple representations. In the present application, it should be understood that the terms “includes” or “comprises” and/or “including” or “comprising”, and variants thereof are used to specify the presence of other components, steps, operations, and/or elements mentioned herein, but are not intended to exclude the possibility of the presence or supplement of one or more other components, steps, operations, and/or elements.

Unless there is another definition, all terms (including technical and scientific terminologies) as used herein may be used as meaning that may be commonly understood by those having ordinary skill in the art. Further, unless specifically defined clearly, terms that are defined in advance commonly used are not to be construed ideally or excessively.

Further, in the following description, well-known functions or constitutions will not be described in detail if they would obscure the subject matter of the present disclosure in unnecessary detail. Moreover, the terminologies to be described below are defined in consideration of functions in the present disclosure and may vary depending on the intentions or practices of a user or an operator. Accordingly, the definition may be made on the basis of the content throughout the specification.

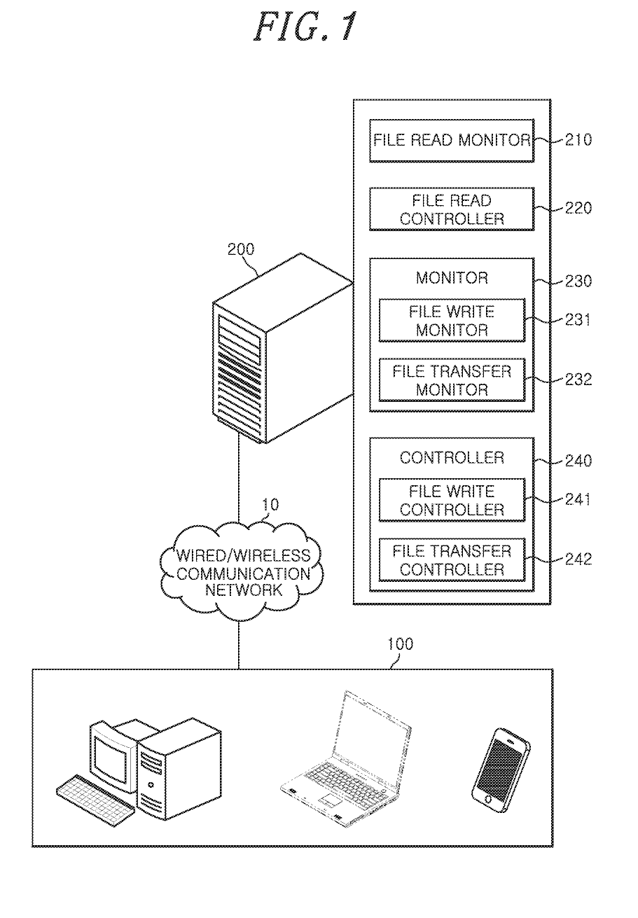

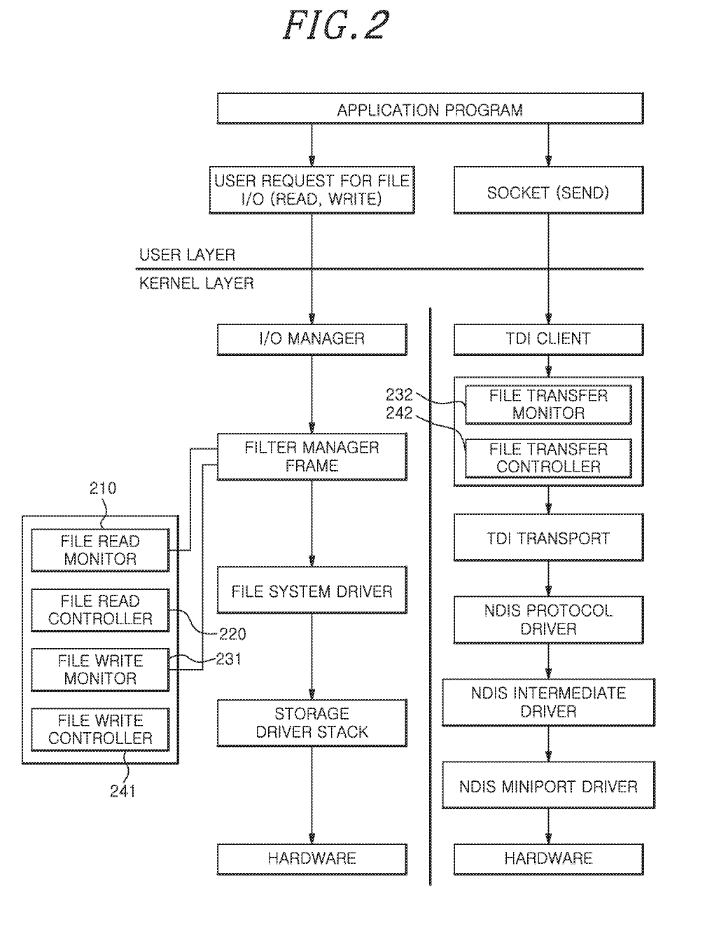

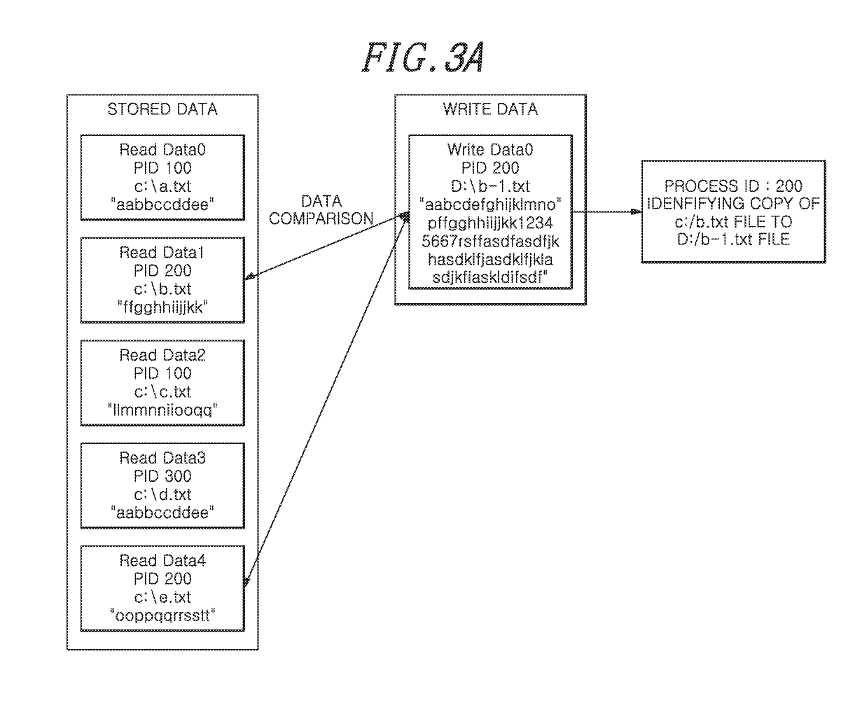

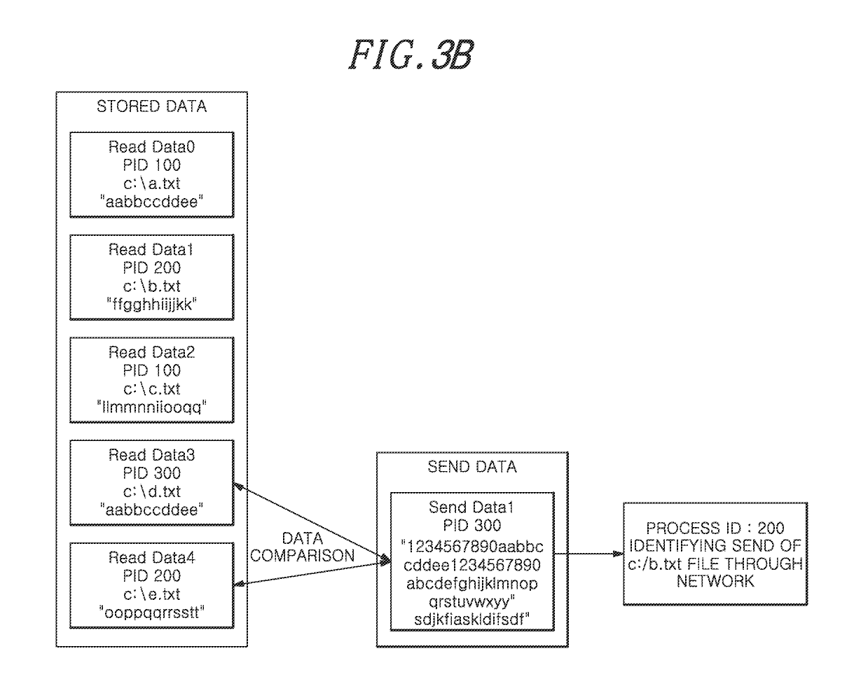

FIG. 1 is an overall block diagram of a system for providing storage security of a cloud server in a cloud computing environment in accordance with an embodiment of the present invention, FIG. 2 illustrates a detailed diagram of the kernel structure of a file and network system in a cloud server that is applied in an embodiment of the present invention, and FIGS. 3A and 3B are diagrams illustrating the comparison of information on file data through a file write controller that is applied in an embodiment of the present invention.

Referring to FIG. 1 to FIGS. 3A and 3B, a system for providing storage security of a cloud server in a cloud computing environment in accordance with an embodiment of the present invention is a system to provide storage security of a cloud server 200 in a cloud computing environment in which a client terminal 100 is connected to the cloud server 200 over a wired/wireless communication network 10. The system generally includes a file read monitor 210; a file read controller 220; a monitor 230 including a file write monitor 231 or a file transfer monitor 232; and a controller 240 including a file write controller 241 or a file transfer controller 242.

Here, the client terminal 100 may be typically a personal computer (PC), for example, a desktop PC, notebook PC, or the like, but is not limited thereto, and may be any type of wired/wireless communication device capable of accessing the cloud server 200 over the wired/wireless network 10 to receive the cloud computing service.

For example, the client terminal 100 may generally mean any wired/wireless home appliance or communication device having a user interface for accessing the cloud server 200, such as a Palm PC, personal digital assistant (PDA), smart phone, WAP phone (wireless application protocol phone), mobile gaming machine (e.g., mobile play-station) that can communicate with the cloud server 200 over the wired/wireless network 10.

Meanwhile, the wired/wireless network 10 may be a wired/wireless network or the Internet. The Internet may means a global open computer network architecture that provides TCP/IP protocol and several services on the upper layer, i.e., HTTP (Hyper Text Transfer Protocol), Telnet, FPT (File Transfer Protocol), DNS (Domain Name System), SMTP (Simple Mail Transfer Protocol), SNMP (Simple Network Management Protocol), NFS (Network File Service), NIS (Network Information Service), and the like and provides environments that enable the client terminal 100 to access the cloud server 200. The Internet may be the wired or wireless Internet, or a core network integrated with a wired public network, a wireless mobile communication network, the mobile Internet, or the like.

In response to the request from the client terminal 100, the cloud server 200 serves to provide a cloud computing service.

Specifically, the cloud server 200 is a server for providing a cloud computing service to the client terminal 100, which provides computing resources requested by the client terminal 100 through the wired/wireless communication network 10. The cloud server 200 provides a computing service allowing the device requested by the client terminal 100 to be used.

The cloud server 200 thus includes a number of storage to store files received from a business operator (a content provider) which provides mass data, for example, such as an application program file, game program file, text data file, document file, picture file, music file, video file, bar code file, etc.

Especially, the cloud server 200 applied in an embodiment of the present invention includes a file read monitor 210; a file read controller 220; a monitor 230 including a file write monitor 231 or a file transfer monitor 232; and a controller 240 including a file write controller 241 or a file transfer controller 242, which are provided for the purpose of storage security.

The file read monitor 210 is installed in a kernel layer of a file system included in the cloud server 200, which performs a function to monitor which file data are read among file data stored in the storage of the cloud server 200.

Specifically, the file read monitor 210 is connected to a filter manager frame level included in a kernel layer in the file system of the cloud server 200 and monitors reading of the file data.

Further, it is preferred that the file read monitor 210 registers an IRP_MJ_READ function and an IRP_MJ_ACQUIRE_FOR_SECTION_SYNCHRONIZATION function, for example, and monitors reading of the file data.

Meanwhile, a kernel layer in the file system of the cloud server 200 is comprised of hardware, storage driver stack, file system driver, filter manager frame, and I/O manager level, as illustrated in FIG. 2.

In this case, the filter manager frame level includes functions to facilitate development of the file system driver, to control a loading order through assigned positions of drivers and to solve a number of problems related to existing filter driver models.

Further, the file system driver level perform tasks to intercept requests for a file system and to block or change the requests before they arrive at an original intended destination.

The file read controller 220 is connected to the file read monitor 210. In case that file data monitored for its reading by the file read monitor 210 is the file data stored in a secure space of a predetermined secure space of storage, the file read controller 220 performs a function to extract and store information of the file data monitored for its reading.

In this case, it is preferred that the information on file data extracted through the file read controller 220 includes at least one of a portion of the relevant file data, a file path, drive information, and a process ID.

Further, it is preferred that the information of the file data extracted by the file read controller 220 is stored in a separate storage space (for example, a memory or a database DB) in a form of a list.

The file write monitor 231 is installed in a kernel layer of the file system included in the cloud server 200. The file write monitor 231 performs a function to monitor which file data is written among the file data stored in the storage of the cloud server 200.

Specifically, the file writing monitor 231 is connected to a filter manager frame level included in the kernel layer in the file system of the cloud server 200 so as to monitor writing of the file data.

Further, it is preferred that the file writing monitor 231 registers a function of IRP_MJ_WRITE, for example, so as to monitor writing of the file data.

The file write controller 241 is connected to the file writing monitor 231. The file write controller 241 performs a function to identify whether file data, which is monitored for its writing by the file writing monitor 231, is a predetermined monitoring target. In case that information of the file data monitored for its writing is identical to information of file data stored by use of the file reading controller 220, the file write controller 241 blocks or holds the writing of the file data according to a predetermined security policy.

Specifically, in case that the file data, which is monitored for its writing by the file writing monitor 231, is identified to be the predetermined monitoring-target, if a identical portion to the file data stored and read by the file reading controller 220 is founded in contents of the file data that is tried for file writing when being read in the same process, the file write controller 241 determines that the writing is intended to copy the file data tried to read in the past, compares a destination of the relevant file data, and blocks or holds the writing of the file data when the destination is the outside or the location that violates the predetermined security policy.

The file transfer monitor 232 is installed in the kernel layer of the network system included in the cloud server 200. The file transfer monitor 232 performs a function to monitor which file data is transferred over a network among the file data stored in the storage of the cloud server 200.

In other words, the file transfer monitor 232 is connected between a TDI (Transport Driver Interface) client level and a TDI TransPort level included in the kernel layer in the network system of the cloud server 200 so as to monitor the transfer of file data.

Further, it is preferred that the file transfer monitor 232 registers a TDI_SEND function and a TDI_SEND_DATAGRAM function to monitor the transfer of the file data.

Meanwhile, the kernel layer in the network system of the cloud server 200 is comprised of hardware, NDIS miniport driver, NDIS intermediate driver, NDIS protocol driver, TDI TransPort, and TDI client levels, as illustrated in FIG. 2.

The TDI client calls an IRP_MJ_CREATE function in order to generate or open a file object, i.e., a TDI file object, to embody a TransPort address, a connection end point or a control channel. Such a call enables an I/O manager to assign IRP, to align TDI client provision parameters in the IRP, and to transfer the IRP to a TdiDispatchCreate routine of a lower TDI TransPort driver. When the TDI TransPort driver sets all status to be maintained for newly generated file objects, the TDI TransPort driver calls an IoCompleteRequest (or TdiCompleteRequest) function with IRP and STATUS_SUCCESS.

Then, an IRP_MJ_CREATE function returns to the TDI client with a handle for the file object. Although two clients described same TransPort address when calling their IRP_MJ_CREATE functions, the call of the IRP_MJ_CREATE function in each client process generates a separate TDI file object. When the call of the IRP_MJ_CREATE function succeeds, a transport address, a connection end point or a control channel can be opened depending on EaXxx parameter that is transferred at the call by the client.

The file transfer controller 242 is connected to the file transfer monitor 232. The file transfer controller 242 identifies whether the file data, which is monitored for its transfer by the file transfer monitor 232, is a predetermined network monitoring target. Then, when information of the file data monitored for its writing is identical to the file data stored by use of the file read controller 220, the file transfer controller 242 performs a function to block or holds the transfer of the file data according to a predetermined security policy.

Specifically, in case that the file data, which is monitored for its transfer by the file transfer monitor 232, is a predetermined network monitoring target, if a portion identical to the file data stored and read by the file read controller 220 is founded in contents of the file data that is tried for file transfer when being read in the same process, the file transfer controller 242 determines that the tried file transfer of relevant file is intended to transfer the file data trying to read in the past to the outside over a network.

Hereinafter, a method for providing storage security of a cloud server in a cloud computing environment in accordance with an embodiment of the present invention will be described in detail.

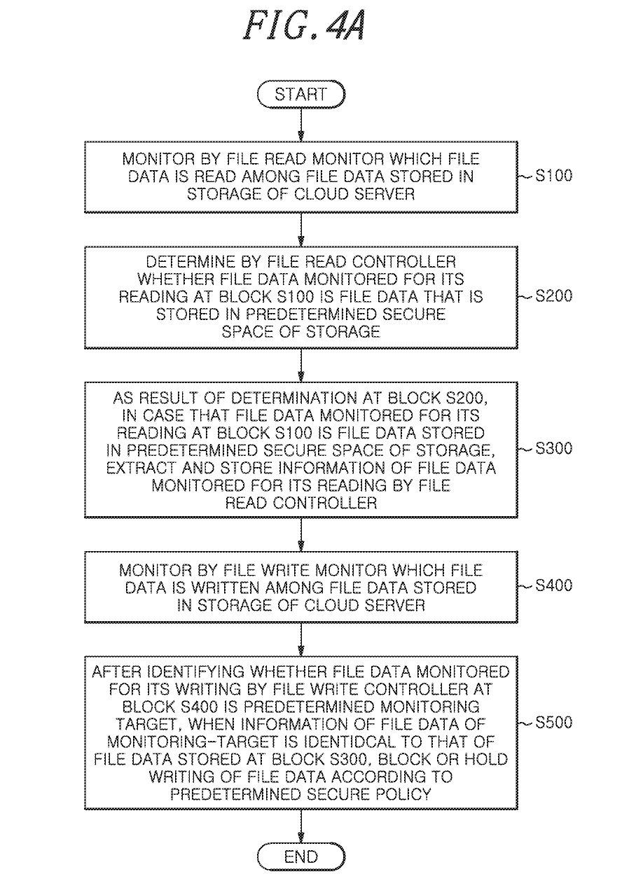

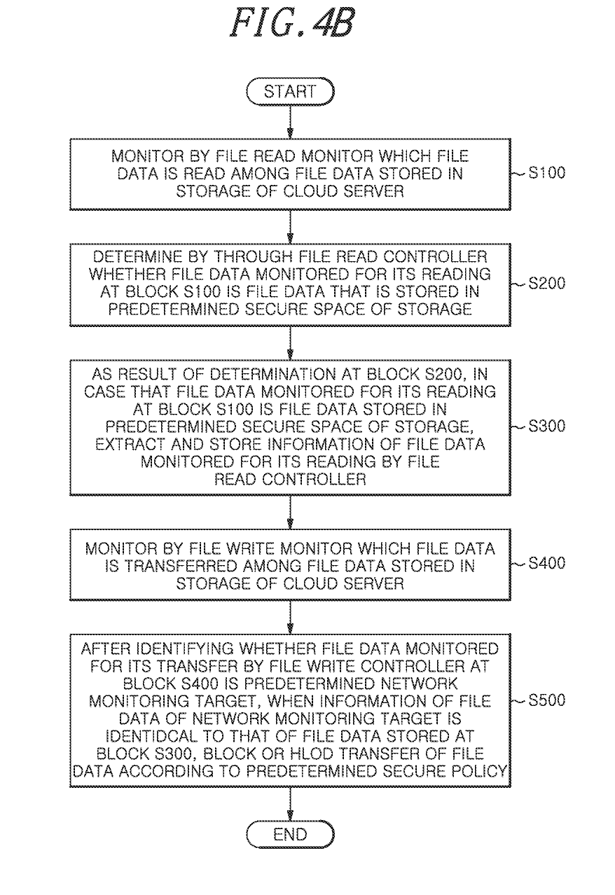

FIGS. 4A and 4B are overall flowcharts illustrating a method for providing storage security of a cloud server in a cloud computing environment in accordance with an embodiment of the present invention.

Referring to FIG. 4A, the method for providing storage security of a cloud server in a cloud computing environment begins to monitor which file data is read among file data stored in a storage of the cloud server 200 through the use of the file read monitor 210 included in the cloud server 200 (Block S100).

In this case, at Block S100, it is preferred that the file read monitor 210 is connected to a filter manager frame level included in a kernel layer within a file system of the cloud server 200 and monitors reading of the file data.

It is also preferred, at Block S100, that the file read monitor 210 registers an IRP_MJ_READ function and an IRP_MJ_ACQUIRE_FOR_SECTION_SYNCHRONIZATION function and then monitors reading of the file data.

Next, it is determined whether the file data, which is monitored for its reading by use of the file read controller 220 connected to the file read monitor 210, at Block S100 is the file data that is stored in a predetermined secure space of the storage (Block S200).

When the file data monitored at Block S100 is determined to be the file data stored in the predetermined secure space of the storage from the determination result at Block S200, the information on the file data monitored for its reading is extracted and stored by the file read controller 220 (Block S300).

In this case, at Block S300, it is preferred that the information on file data extracted through the file read controller 220 is comprised of at least one of a portion of the relevant file data, a file path, drive information and a process ID, for example.

Next, the file write monitor 231 included in the cloud server 200 monitors which file data is written among the file data stored in the storage of the cloud server 200 (Block S400).

In this case, at Block S400, it is preferred that the file write monitor 231 is connected to a filter manager frame included in a kernel layer in a file system of the cloud server 200 and monitors the writing of file data.

Further, it is preferred, at Block S400, that the file write monitor 231 registers an IRP_MJ_WRITE function and monitors writing of file data, for example.

Thereafter, after identifying whether file data monitored for its writing at the step S400 is a predetermined monitoring target through the use of the file write controller 241 connected to the file write monitor 231, for example, identifies whether the file data monitored for its writing is the monitoring target to be priorly monitored, the file position in which the file data is written is identified so as to identify that the file position is a hard disk drive, an USB drive or a network drive, and the writing of the relevant file data is blocked or held according to a predetermined security policy if information of the file data of the monitoring target is identical to that of the file data stored at Block S300 (S500).

In other words, at Block S500, in case that the file data monitored for its writing by the file write monitor 231 is the predetermined monitoring-target, if a portion identical to the file data stored and read at the step S300 is founded among contents of file data that is tried for file writing when trying to read in the same process, the file write controller 241 determines that the writing is intended to copy the file data that is tried to read in the past, determines a destination of the relevant file data, and blocks or holds the writing of the relevant file data when the destination is the outside or the location that violates a predetermined security policy.

Alternatively, referring to FIG. 4B, a method for providing storage security of a cloud server in a cloud computing environment in accordance with an embodiment of the present invention begins to monitor which file data is read among file data stored in a storage of the cloud server 200 through the use of the file read monitor 210 included in the cloud server 200 (Block S100).

In this case, at Block S100, it is preferred that the file read monitor 210 is connected to a filter manager frame included in a kernel layer in a file system of the cloud server 200 and monitors reading of the file data.

Further, it is preferred, at Block S100, that the file read monitor 210 registers an IRP_MJ_READ function and an IRP_MJ_ACQUIRE_FOR_SECTION_SYNCHRONIZATION function and monitors reading of the file data, for example.

Next, it is determined whether the file data monitored for its reading at Block S100 through the use of the file read controller 220 connected to the file read monitor 210 is the file data that are stored in a predetermined secure space of the storage (Block S200).

When the file data monitored for its reading at Block S100 is determined to be the file data stored in the predetermined secure space of the storage from the determination result at Block S200, the information on the file data monitored for its reading is extracted and stored through the use of the file read controller 220 (Block S300).

In this case, at Block S300, it is preferred that the information on file data extracted through the file read controller 220 is comprised of at least one of a portion of the file data, a file path, drive information and a process ID, for example.

Next, it is monitored which file data are transferred sent through the file transfer monitor 232 included in the cloud server 200 among the file data stored in the storage of the cloud server 200 (Block S400).

In this case, at Block S400, it is preferred that the file transfer monitor 232 is connected between a TDI (Transport Driver Interface) client level included in a kernel layer in the network system of the cloud server 200 and a TDI TransPort level and monitors the transfer of file data.

Thereafter, after identifying whether the file data monitored for its transfer at Block S400 through the use of the file transfer controller 242 connected to the file transfer monitor 232 is a predetermined network monitoring target, if information of the file data of the predetermined network monitoring-target is identical to that of the file data stored at Block S300, the transfer of the relevant file data is blocked or held according to a predetermined security policy (Block S500).

That is, at Block S500, in case that the file data monitored for its transfer by the file transfer monitor 232 is the predetermined network monitoring target, if a portion identical to the file data read and stored at Block S300 is founded among contents of file data that is tried for file transfer when trying to read in the same process, the file transfer controller 242 determines that the relevant file data trying to transfer is intended to transfer the file data that was tried to transfer in the past to the outside over a network.

Meanwhile, the method for providing storage security of a cloud server in a cloud computing environment in accordance with an embodiment of the present invention may also be implemented as computer-readable codes in a computer-readable recording medium. The computer-readable recording medium includes any type of recording devices in which data readable by a computer system is stored.

For example, the computer-readable recording mediumstorage medium includes CD-ROM, magnetic tape, hard disk, floppy disk, mobile storage device, non-volatile memory (e.g., flash memory), optical data storage device and the like.

Also, the computer-readable medium may be distributed to computer systems connected via a computer communication network and the codes that can be read in a distribution scheme may be stored and executed in the computer-readable recording medium.

While the invention has been shown and described with respect to the a preferred embodiment of a system for providing storage security of a cloud server in a cloud computing environment and a method thereof, the present invention is not limited thereto. Various modifications can be made to the above-described exemplary embodiments of the present invention without departing from the spirit or scope of the invention and are intended to be embraced by the scope of the present invention.

What is claimed is:

1. An apparatus for providing a storage security of a cloud server in a cloud computing environment in which a client terminal is connected to the cloud server over a communication network, the apparatus comprising:
a monitor configured to monitor which file data is requested for writing or transferring among file data stored in a storage of the cloud server; and
a controller configured to detect whether the file data monitored by the monitor is the file data belonging to a predetermined secure space and to block or hold the writing or transfer for the file data when the detected file data belongs to the predetermined secure space.

2. The apparatus of claim 1, wherein the controller blocks or holds the writing or transfer for the detected file data based on a predetermined security policy.

3. The apparatus of claim 1, further comprising:
a file read monitor installed in a kernel layer of a file system included in the cloud server and configured to monitor which file data is read among the file data stored in the storage of the cloud server; and
a file read controller configured, in case that file data monitored for its reading by the file read monitor is the file data stored in the predetermined secure space, to extract and store information of the file data monitored for its reading.

4. The apparatus of claim 3, wherein the controller is configured to:
identify whether the file data monitored by the monitor is a predetermined monitoring target, before detecting whether the file data monitored by the monitor is the file data belonging to the predetermined secure space; and
in case that information of the file data monitored by the monitor is identical to information of the file data stored by the file read controller, determine that the file data monitored by the monitor is the file data belonging to the predetermined secure space.

5. The apparatus of claim 3, wherein information of the file data extracted by the file read controller is stored in a separate storage space in a form of list and includes at least one of a portion of the relevant file data, a file path, drive information, and a process ID.

6. The apparatus of claim 3, wherein the monitor further comprises:
a file write monitor that is installed in a kernel layer of a file system included in the cloud server and that monitors which file data is written among the file data stored in the storage of the cloud server.

7. The apparatus of claim 6, wherein in case that the file data monitored for its writing by the file write monitor is a predetermined monitoring target, when a portion identical to the file data stored and read by the file read controller is founded in contents of the file data that try to write file when reading in the same process, the controller is configured to:
determine that the writing is intended to copy the file data that was tried to read in the past, determine a destination of the relevant file data; and
block or hold the writing of the relevant file data when the destination is the outside or the location that violates a predetermined security policy.

8. The apparatus of claim 3, wherein the monitor further comprises:
a file transfer monitor that is installed in the kernel layer of the network system included in the cloud server and that is configured to monitor which file data is transferred among the file data stored in the storage of the cloud server.

9. The apparatus of claim 8, wherein in case that the file data t monitored for tis transfer by the file send monitor is a predetermined network monitoring target, when a portion identical to the file data stored and read by the file read controller is founded in contents of the file data that was tried for file transfer in the same process, the controller is configured to:
determine that the file data trying for file transfer is intended to transfer the file data that was tried to read in the past to the outside.

10. A method for providing a storage security of a cloud server in a cloud computing environment in which a client terminal is connected to the cloud server over a communication network, the method comprising:
monitoring, by a monitor installed in a kernel layer of a system that is included in the cloud server, whether there is a writing request or transfer request for a file data among file data stored in a storage of the cloud server;
detecting, by a controller connected to the monitor, whether the file data monitored in the monitoring step is the file data belonging to a predetermined secure space; and
when the file data monitored is detected to be the file data belonging to the predetermined secure space, controlling the controller to block or hold a writing or transfer of the file data detected.

11. The method of claim 10, wherein in the controlling step, the controller is configured to block or hold the writing or transfer of the file data detected, based on a predetermined security policy.

12. The method of claim 10, further comprising, before the monitoring step:
monitoring, by a file read monitor installed in a kernel layer of the file system included in the cloud server, which file data is read among the file data stored in the storage of the cloud server; and
in case that the file data monitored for its reading by the file read monitor is the file data stored in the predetermined secure space, controlling a file read controller connected to the file read monitor to extract and store information of file data monitored for its reading.

13. The method of claim 12, wherein the detecting step comprises:
before detecting whether the file data monitored by the monitor is the file data belonging to the predetermined secure space, allowing the controller to identify whether the file data monitored by the monitor is the predetermined monitoring target; and
in case that information of the file data monitored by the monitor is identical to information of the file data stored by the file read controller, allowing the controller to determine that the file data is the file data belonging to the predetermined secure space.

14. The method of claim 12, wherein information of the file data extracted by the file read controller at the controlling step is stored in a separate storage space in a form of list and includes at least one of a portion of the relevant file data, a file path, drive information and a process ID.

15. The method of claim 12, wherein the monitoring step further comprises:
monitoring, by a file write monitor that is installed in a kernel layer of a file system included in the cloud server and included in the monitor, which file data is written among file data stored in the storage of the cloud server.

16. The method of claim 15, wherein in case that the file data monitored for its writing by the file write monitor is determined to be the monitoring target, when a portion identical to the file data stored and read by the file read controller is founded in contents of the file data that is tried to write file when reading in the same process, the controlling step comprises:
determining that the writing is intended to copy the file data that was tried for reading in the past;
determining a destination of the relevant file data; and
blocking or holding the writing of the file data when the destination is the outside or the site that violates the predetermined security policy.

17. The method of claim 12, wherein the monitoring step comprises:
monitoring, by a file transfer monitor that is installed in a kernel layer of a network system included in the cloud server and is included in the monitor, which file data is transferred among the file data stored in the storage of the cloud server.

18. The method of claim 17, wherein in case that the file data monitored for its sending by the file send monitor is a predetermined network monitoring-target, when a portion identical to the file data stored and read by the file read controller is founded in contents of the file data that is tried to send file when trying to read in the same process, the controlling step comprises:
determining that the file data trying for file transfer is intended to transfer the file data that was tried to read in the past to the outside.
